(19) United States
(12) Patent Application Publication
(10) Pub. No.: US 2025/0278896 A1
(43) Pub. Date: Sep. 4, 2025

(54) FAST SINGLE IMAGE TO 3D OBJECTS GENERATION

(71) Applicant: The Regents of the University of California, Oakland, CA (US)

(72) Inventors: Hao Su, San Diego, CA (US); Minghua Liu, San Diego, CA (US); Ruoxi Shi, San Diego, CA (US)

(21) Appl. No.: 19/069,011

(22) Filed: Mar. 3, 2025

Related U.S. Application Data
(60) Provisional application No. 63/560,998, filed on Mar. 4, 2024.

(51) Int. Cl. G06T 17/20; B25J 9/16; G06T 5/60; G06T 5/70; G06T 15/04; G06T 15/08

(52) U.S. Cl. CPC G06T 17/20; B25J 9/163; B25J 9/1666; G06T 5/60; G06T 5/70; G06T 15/04; G06T 15/08; G06T 2207/20084; G06T 2210/21

(57) ABSTRACT

Disclosed are systems and methods for generating a 3D model from a single 2D image, the method comprising: receiving a single 2D input image of an object; generating a set of consistent multi-view images based on the single 2D input image using a fine-tuned 2D diffusion model that processes multiple views together in a tiled configuration; constructing a 3D feature volume by projecting 2D patch features from the generated multi-view images using corresponding camera pose information; generating a 3D mesh using a pair of 3D diffusion networks conditioned on the multi-view images, wherein the pair of 3D diffusion networks comprises a first network for generating a coarse occupancy volume and a second network for generating a high-resolution sparse volume; and refining a texture of the generated 3D mesh to produce a textured 3D mesh.

### CROSS-REFERENCE TO RELATED APPLICATIONS

The present application claims the benefit of U.S. Provisional Patent Application No. 63/560,998, filed Mar. 4, 2024, and titled “FAST SINGLE IMAGE TO 3D OBJECTS GENERATION,” which is incorporated herein by reference in its entirety for all purposes.

### BACKGROUND

With the rapid adoption of generative artificial intelligence (AI), one of the most popular areas is 2D and 3D image generation. Recent advancements in open-world 3D object generation have been remarkable, with image-to-3D methods offering superior fine-grained control over their text-to-3D counterparts. However, most existing models fall short in simultaneously providing rapid generation speeds and high fidelity to input images-two features essential for practical applications.

### SUMMARY

In some example embodiments, there may be provided a machine learning based way to generate three-dimensional (3D) objects from a single image.

The details of one or more variations of the subject matter described herein are set forth in the accompanying drawings and the description below. Other features and advantages of the subject matter described herein will be apparent from the description and drawings, and from the claims.

In one aspect, disclosed is a method for generating a three-dimensional (3D) model from a single two-dimensional (2D) image, the method comprising: receiving a single 2D input image of an object; generating a set of consistent multi-view images based on the single 2D input image using a fine-tuned 2D diffusion model that processes multiple views together in a tiled configuration; constructing a 3D feature volume by projecting 2D patch features from the generated multi-view images using corresponding camera pose information; generating a 3D mesh using a pair of 3D diffusion networks conditioned on the multi-view images, wherein the pair of 3D diffusion networks comprises a first network for generating a coarse occupancy volume and a second network for generating a high-resolution sparse volume; and refining a texture of the generated 3D mesh to produce a textured 3D mesh.

In some embodiments, generating the set of consistent multi-view images comprises: tiling six views into a single image with a 3×2 layout; defining camera poses for the multi-view images using fixed absolute elevation angles alternating between about 30° and about −20°, coupled with azimuths commencing at about 30° and incrementing by about 60° for each subsequent pose; and generating the tiled image using the fine-tuned 2D diffusion model conditioned on the single 2D input image.

In some embodiments, the fine-tuned 2D diffusion model incorporates: local conditioning through reference attention that appends self-attention key and value matrices from the conditional reference image to corresponding attention layers for the multi-view image; global conditioning using CLIP (Contrastive Language-Image Pre-Training) image embedding as a global semantic understanding of the object; and a linear noise scheme for the diffusion process.

In some embodiments, generating the 3D mesh comprises: initializing a low-resolution 3D grid with Gaussian noise; denoising the grid using the first diffusion network to produce a coarse occupancy volume; subdividing each predicted occupied voxel into smaller voxels to construct a high-resolution sparse volume; initializing the sparse volume with Gaussian noise; denoising the sparse volume using the second diffusion network to predict signed distance function (SDF) values and color for each voxel; and applying a Marching Cubes algorithm to extract a textured mesh from the denoised volume.

In some embodiments, refining the texture of the generated 3D mesh comprises: rendering the 3D mesh from multiple views that match the camera poses of the generated multi-view images; comparing the rendered views with the generated multi-view images; optimizing a color field to minimize differences between the rendered views and the generated multi-view images using a l2 loss function; and transferring the optimized color field to the mesh surface.

In some embodiments, the method further comprises: processing the generated textured 3D mesh to create simplified collision models for physical simulation; analyzing the geometric properties of the 3D mesh to identify potential grasping points and manipulation affordances; and using the identified affordances to guide robot interaction planning when working with objects resembling the generated 3D model.

In some embodiments, the method further comprises training a robot to interact with physical objects by using the generated textured 3D mesh in a simulation environment that simulates physical interactions between the robot and virtual representations of the physical objects.

In some embodiments, the method further comprises generating multiple different 3D meshes of various objects from corresponding 2D input images; populating a virtual training environment with the generated 3D meshes; and training the robot in the virtual training environment to perform grasping, manipulation, and navigation tasks with respect to objects represented by the 3D meshes.

In some embodiments, training the robot in the virtual environment further comprises: generating variations of the 3D meshes with different textures, sizes, and orientations to enhance the robustness of the robot's learned policies; simulating different lighting conditions and environmental factors to improve the generalization capability of the robot; and gradually increasing the complexity of manipulation tasks to enable progressive learning.

In some embodiments, training the robot in the simulation environment comprises: simulating physics-based interactions between the robot and the generated 3D objects; collecting training data from the simulated interactions; using the collected data to train machine learning models that predict optimal grasping points, manipulation strategies, and object recognition capabilities; and deploying the trained models on physical robots to enable effective interaction with real-world counterparts of the simulated objects.

Another aspect is a system for generating a three-dimensional (3D) model from a single two-dimensional (2D) image, the system comprising: one or more processors; and memory storing instructions that, when executed by the one or more processors, cause the system to: receive a single 2D input image of an object; generate a set of consistent multi-view images based on the single 2D input image using a fine-tuned 2D diffusion model that processes multiple views together in a tiled configuration; construct a 3D feature volume by projecting 2D patch features from the generated multi-view images using corresponding camera pose information; generate a 3D mesh using a pair of 3D diffusion networks conditioned on the multi-view images, wherein the pair of 3D diffusion networks comprises a first network for generating a coarse occupancy volume and a second network for generating a high-resolution sparse volume; and refine a texture of the generated 3D mesh to produce a textured 3D mesh.

In some embodiments, generating the set of consistent multi-view images comprises: tiling multiple views of the object into a single composite image arranged in a grid layout; and generating the composite image using the fine-tuned 2D diffusion model conditioned on the single 2D input image, enabling cross-view attention during the diffusion process.

In some embodiments, the fine-tuned 2D diffusion model is configured to generate the multi-view images with predetermined camera poses comprising: fixed absolute elevation angles; and relative azimuth angles with respect to the input image view.

In some embodiments, the first network of the pair of 3D diffusion networks generates a low-resolution occupancy volume using 3D convolution, and the second network generates a high-resolution sparse volume using 3D sparse convolution.

In some embodiments, the instructions further cause the system to refine the texture of the generated 3D mesh by: optimizing a color field represented by a tensor radiance field (TensoRF) while maintaining the geometry of the generated 3D mesh; and baking the optimized color field onto the mesh.

In some embodiments, constructing the 3D feature volume comprises: extracting 2D patch features from each of the multi-view images using a pre-trained vision model; projecting each 3D voxel within the 3D feature volume onto the multi-view images using known camera poses; and aggregating corresponding 2D patch features through a shared-weight multilayer perceptron followed by max pooling.

In some embodiments, the instructions further cause the system to perform text-to-3D generation by: receiving a text prompt describing an object; synthesizing a reference image based on the text prompt using a text-to-image model; and processing the synthesized reference image through the consistent multi-view generation and 3D diffusion pipeline to produce a textured 3D mesh corresponding to the text prompt.

In some embodiments, the instructions further cause the system to train a robot to interact with physical objects by using the generated textured 3D mesh in a simulation environment that simulates physical interactions between the robot and virtual representations of the physical objects.

In some embodiments, the instructions further cause the system to: generate multiple different 3D meshes of various objects from corresponding 2D input images; populate a virtual training environment with the generated 3D meshes; and train the robot in the virtual training environment to perform object manipulation tasks before deployment in a physical environment.

In some embodiments, training the robot using the simulation environment comprises: using reinforcement learning to train robot control policies based on interactions with the generated 3D meshes; and transferring the learned policies to a physical robot for real-world object manipulation.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings, which are incorporated in and constitute a part of this specification, show certain aspects of the subject matter disclosed herein and, together with the description, help explain some of the principles associated with the disclosed implementations. In the drawings,

FIG. 1 shows non-limiting examples of sets of 2D images and their corresponding textured mesh and normal map, in accordance with some embodiments.

FIG. 2 shows a non-limiting process of generating a 3D image from a 2D image, in accordance with some embodiments.

FIG. 3 shows a non-limiting process of generating and stitching multi-view images into a single frame, in accordance with some embodiments.

FIG. 4 shows a non-limiting process of extracting patches to generating feature volumes and then performing 3D diffusion, in accordance with some embodiments.

FIG. 5 shows non-limiting examples of sets of 2D images and their corresponding textured mesh and normal map, in accordance with some embodiments.

FIG. 6 shows a non-limiting example of a user study that was conducted, in accordance with some embodiments.

FIG. 7 shows non-limiting sets of examples of input images and multi-view renderings of the generated meshes, in accordance with some embodiments.

FIG. 8 shows a non-limiting set of results of various approaches of text-to-3D, in accordance with some embodiments.

FIG. 9 shows a non-limiting system that is configured to implement the described technology, in accordance with some embodiments.

### DETAILED DESCRIPTION

Herein is disclosed, in accordance with some embodiments, “One-2-3-45++” which refers to an innovative way to transform a single image into a detailed 3D textured mesh in, for example, approximately one minute. The approach aims to fully harness the extensive knowledge embedded in two-dimensional (2D) diffusion models and priors from valuable yet limited 3D data. This may be achieved by initially finetuning a 2D diffusion model for consistent multi-view image generation, followed by elevating these images to 3D with the aid of multi-view conditioned 3D native diffusion models. Extensive experimental evaluations demonstrate that the disclosed method can produce high-quality, diverse 3D assets that closely mirror the original input image.

### Introduction

3D generation has garnered significant attention in recent years. Before the advent of large-scale pre-trained 2D models, researchers often delved into 3D native generative models that learn directly from 3D synthetic data or real scans and generate various 3D representations such as point clouds, 3D voxels, polygon meshes, parametric models, and implicit fields. However, given the limited availability of 3D data, these models tended to focus on a select number of categories (e.g., chairs, cars, planes, humans, etc.), struggling to generalize to unseen categories in the open world.

The advent of recent 2D generative models (e.g., DALL-E, Imagen, and Stable Diffusion) and vision-language models (e.g., CLIP) has equipped us with powerful priors about our 3D world, consequently fueling a surge of research in 3D generation. Notably, models like DreamFusion, Magic3D, and Prolific-Dreamer have pioneered a line of approach for per-shape optimization. These models are designed to optimize a 3D representation for each unique input text or image, drawing on the 2D prior models for gradient guidance. While they have yielded impressive results, these methods tend to suffer from prolonged optimization times, the “multi-face problem”, oversaturated colors, and a lack of diversity in results. Some works also concentrate on creating textures or materials for input meshes, utilizing the priors of 2D models.

A new wave of studies, highlighted by works like Zero123, has showcased the promise of using pre-trained 2D diffusion models for synthesizing novel views from singular images or texts, opening new doors for 3D generation. For instance, One-2-3-45, using multi-view images predicted by Zero123, can produce a textured 3D mesh in a mere 45 seconds. Nevertheless, the multi-view images produced by Zero123 lack 3D consistency.

While traditional 3D reconstruction methods, such as multi-view stereo or NeRF-based techniques, often demand a dense collection of input images for accurate geometry inference, many of the latest generalizable NeRF solutions strive to learn priors across scenes. This enables them to infer NeRF from a sparse set of images and generalize to novel scenes. These methods typically ingest a few source views as input, leveraging 2D networks to extract 2D features. These pixel features are then unprojected and aggregated into 3D space, facilitating the inference of density (or SDF) and colors. However, these methods may either rely on consistent multi-view images with accurate correspondences or possess limited priors to generalize beyond training datasets.

Recently, some methods have employed diffusion models to aid sparse view reconstruction tasks. However, they generally frame the problem as novel view synthesis, necessitating additional processing, such as distillation using a 3D representation, to generate 3D content. The described technology utilizes a multi-view conditioned 3D diffusion model for 3D generation. This model directly learns priors from 3D data and obviates the need for additional post-processing. Moreover, some concurrent works employ NeRF-based per-scene optimization for reconstruction, leveraging specialized loss functions.

Generating 3D shapes from a single image or text prompt is a long-standing problem in computer vision and is essential for numerous applications. While remarkable progress has been achieved in the field of 2D image generation due to advanced generative methods and large-scale image-text datasets, transferring this success to the 3D domain is hindered by the limited availability of 3D training data. Although many works introduce sophisticated 3D generative models, a majority of prior works rely solely on 3D shape datasets for training. Given the limited size of publicly available 3D datasets, these methods often struggle to generalize across unseen categories in open-world scenarios.

Another line of work, exemplified by DreamFusion (Poole et al. “DreamFusion: Text-to-3D Using 2D Diffusion.” arXiv preprint arXiv:2209.14988, 2022.), Magic3D (Lin et al. “Magic3D: High-Resolution Text-to-3D Content Creation.” In Proceedings of the IEEE/CVF Conference on Computer Vision and Pattern Recognition, pages 300-309, 2023.) harnesses the expansive knowledge or robust generative potential of 2D prior models like CLIP (Radford et al. “Learning transferable visual models from natural language supervision.” In International Conference on Machine Learning, pages 8748-8763. PMLR, 2021.) and Stable Diffusion. They typically optimize a 3D representation (e.g., NeRF or mesh) from scratch for each input text or image. During the optimization process, the 3D representation is rendered into 2D images, and the 2D prior models are employed to calculate gradients for them. While these methods have yielded impressive outcomes, the per-shape optimization can be exceedingly time-intensive, requiring tens of minutes or even hours to generate a single 3D shape for each input. Moreover, they frequently encounter the “multi-face” or Janus problem, produce results with oversaturated colors and artifacts inherited from the NeRF or triplane representation, and face challenges in generating diverse results across different random seeds.

A recent work “One-2-3-45” (Liu et al. “One-2-3-45: Any Single Image to 3D Mesh in 45 Seconds Without Per-Shape Optimization.” arXiv preprint arXiv:2306.16928, 2023.) presented a way to leverage rich priors of 2D diffusion models for 3D content generation. It initially predicts multi-view images via a view-conditioned 2D diffusion model, Zero123 (Liu et al. “Zero-1-to-3: Zero-Shot One Image to 3D Object.” In Proceedings of the IEEE/CVF International Conference on Computer Vision, pages 9298-9309, 2023.). These predicted images are subsequently processed through a generalizable NeRF method for 3D reconstruction. Although One-2-3-45 can produce 3D shapes in a single feed-forward pass, its efficacy is often constrained by the inconsistent multi-view predictions of Zero123, leading to compromised 3D reconstruction results.

Herein, is disclosed “One-2-3-45++”, which is a novel method that effectively overcomes the shortcomings of One-2-3-45, delivering significantly enhanced robustness and quality. Taking a single image of any object as input, One-2-3-45++ may also include two primary stages: 2D multi-view generation and 3D reconstruction. During the initial phase, rather than employing Zero123 to predict each view in isolation, One-2-3-45++ may simultaneously or substantially simultaneously predict or generate consistent multi-view images. This may be realized by tiling a concise set of six-view images into a single image and then finetuning a 2D diffusion model to generate this combined image conditioned on the input reference image. In this way, the 2D diffusion net is able to attend to each view during generation, ensuring more consistent results across views. In the second stage, One-2-3-45++ may employ a multi-view conditioned 3D diffusion-based module to predict the textured mesh in a coarse-to-fine fashion. The consistent multi-view conditional images can act as a blueprint for 3D reconstruction, facilitating a zero-shot hallucination capability. Concurrently, the 3D diffusion network excels in lifting the multi-view images, thanks to its ability to harness a broad spectrum of priors extracted from the 3D dataset. One-2-3-45++ employs a lightweight optimization technique to enhance the texture quality efficiently, leveraging consistent multi-view images for supervision.

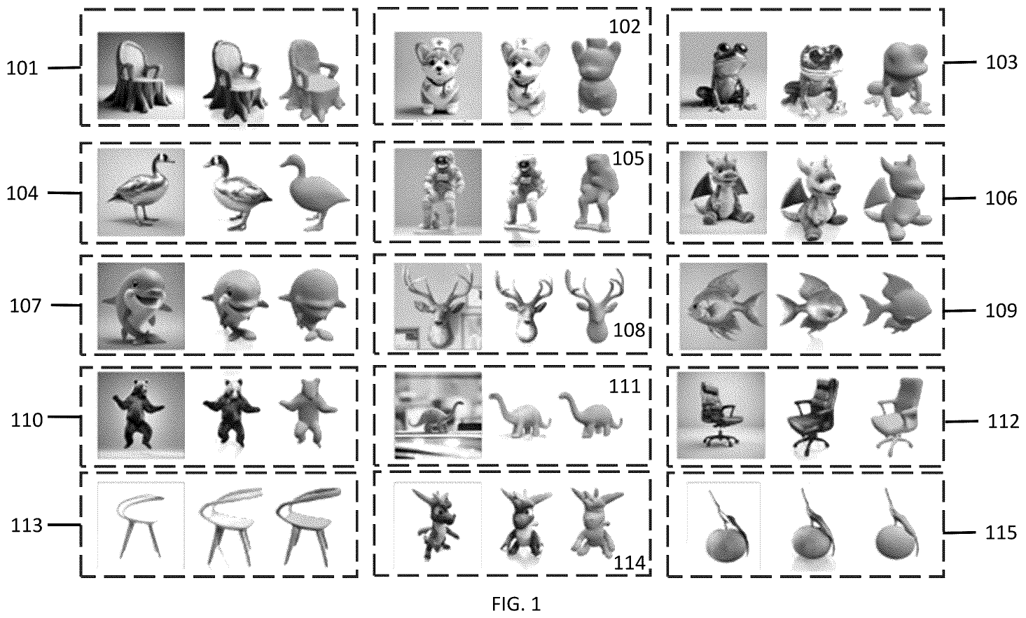

As depicted in FIG. 1, One-2-3-45++ can efficiently generate 3D meshes with realistic textures in under a minute, offering precise fine-grained control. In FIG. 1, 15 sets 101-115 of 3 images are shown. Each set 101-115 includes an input image that was drawn via a text prompt (the leftmost image of each set), a generated textured mesh (the middle image of each set), and a normal map (the rightmost image of each set). For example, the text prompt for set 101 may include “a chair made out of tree stump,” the text prompt for set 102 may include “a plush toy of a corgi nurse,” the text prompt for set 103 may include “a frog wearing black glasses,” the text prompt for set 104 may include “a goose made out of gold,” the text prompt for set 105 may include “a Michelangelo style statue of an astronaut,” and the text prompt for set 106 may include “a plush dragon toy.” Further, the text prompt for set 107 may include “a plush dolphin toy,” the text prompt for set 108 may include “a deer head on a wall,” the text prompt for set 109 may include “a colorful fish,” the text prompt for set 110 may include “a dancing brown bear,” the text prompt for set 111 may include “a long neck dinosaur toy,” the text prompt for set 112 may include “an office chair with arm rests and wheels,” the text prompt for set 113 may include “a four-legged wooden chair,” the text prompt for set 114 may include “a plush purple and yellow dragon toy,” and the text prompt for set 115 may include “an orange with a stem and leaf.” For each of these text prompts, a corresponding input image was generated using generative AI image generation tool (e.g., Stable Diffusion). Then, based on the described technology, a textured mesh of the input image was created (middle image). The normal map was generated based on the textured mesh.

Based on extensive evaluations, including user studies and objective metrics across an extensive test set, highlight One-2-3-45++'s superiority in terms of robustness, visual quality, and, most importantly, fidelity to the input image.

### Generating 3D Images From 2D Images Using One-2-3-45++

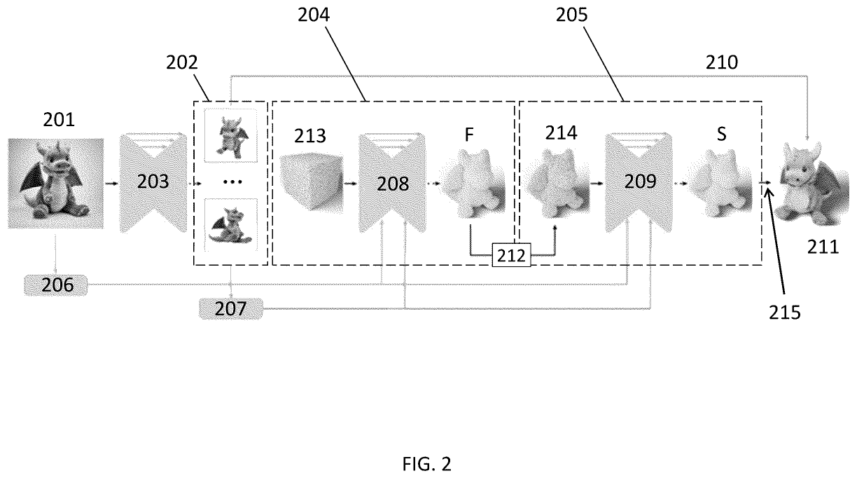

FIG. 2 shows an exemplary process of generating a textured 3D mesh from a 2D image, in accordance with some embodiments. As shown in FIG. 2, the process can start by generating coherent multi-view images 202 of the object based on a single input image 201 of the object. This can be achieved by finetuning 203 a pre-trained 2D diffusion model (e.g., Stable Diffusion UNet). These generated images can then be input into a multi-view conditioned 3D diffusion model for 3D modeling. The 3D diffusion module, trained on extensive multi-view and 3D pairings, excels at converting multi-view images into 3D meshes. Throughout the 3D diffusion process, the generated multi-view images can act as essential guiding conditions. Finally, the produced meshes may undergo a lightweight refinement module 210, guided by the multi-view images, to further enhance the texture quality. This methodology can be used to generate an initial textured mesh within 20 seconds and a refined textured mesh in about one minute.

### Consistent Multi-View Generation

Described is an innovative method to produce consistent multi-view images which significantly benefits downstream 3D reconstruction.

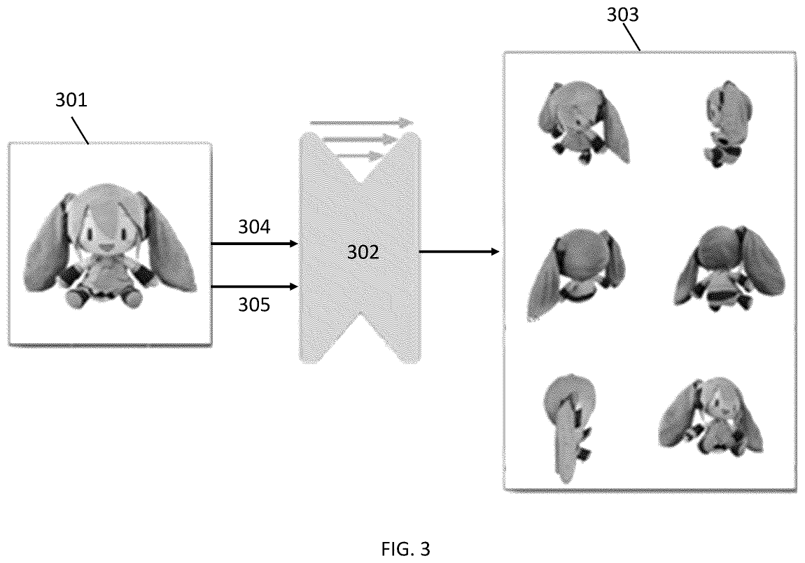

Multi-View Tiling. Referring to FIG. 3, to generate multiple views in a single diffusion process 302, a sparse set of 6 views may be tiled into a single image with a 3×2 layout 303, in accordance with some embodiments. Subsequently, a pre-trained 2D diffusion net may be fine-tuned to generate the composite image, conditioned on a single input image 301. This strategy enables multiple views to interact with each other during the diffusion.

It's nontrivial to define the camera poses of the multi-view images. Given that the 3D shapes within the training dataset lack aligned canonical poses, employing absolute camera poses for the multi-view images could lead to ambiguities for the generative model. Alternatively, if the camera poses were set relative to the input view, as done in Zero123, downstream applications may be required to infer the elevation angle of the input image to deduce the camera poses of the multi-view images. This additional step could introduce errors into the pipeline. To address these, fixed absolute elevation angles paired with relative azimuth angles may be used so as to define the poses of multi-view images, effectively resolving the orientation ambiguity without necessitating further elevation estimation. In some embodiments, the six poses may be determined by alternating elevations of about 30° and about −20°, coupled with azimuths commencing at about 30° and incrementing by about 60° for each subsequent pose, as shown in FIG. 3.

Network and Training Details. To fine-tune Stable Diffusion for adding image conditioning and generating coherent multi-view composite images, three network or training designs may be employed. First, a reference attention technique may be adopted to incorporate local condition 304. For example, the reference input image may be processed with the denoising UNet model, and the self-attention key and value matrices from the conditional reference image may be appended to the corresponding attention layers of the denoising multi-view image. Then, CLIP image embedding may be deployed 305 as a global condition, replacing the text token features originally used in Stable Diffusion. These global image embeddings may be multiplied by a set of learnable weights, providing the network with an overall semantic understanding of the object. Then, the original Stable Diffusion model may be trained using a scaled-linear noise schedule. A linear noise scheme may be used in for fine-tuning.

The fine-tuning process may be performed as follows. In some embodiments, a set of 3D shapes from a dataset may be used (e.g., Objaverse). The fine-tuning may be performed on a model such as Stable Diffusion 2 For each shape, a set number of data points (e.g., 3) may be generated by randomly sampling the camera pose of the input image from a specified range and selecting a random HDRI environment lighting from a curated set that offers uniform lighting. Initially, the fine-tuning may be performed only on the self-attention layers along with the key and value matrices of the cross-attention layers using, e.g., LoRA (Hu et al. “LoRA: Low-Rank Adaptation of Large Language Models.” arXiv preprint arXiv: 2106.09685, 2021). Subsequently, the entire UNet may be fine-tuned using a conservative learning rate.

### 3D Diffusion With Multi-View Condition

While prior work utilizes generalizable NeRF methods for 3D reconstruction, it primarily depends on accurate local correspondence of multi-view images and possesses limited priors for 3D generation. This constrains their effectiveness in lifting intricate and inconsistent multi-view images generated by the 2D diffusion network. Instead, described herein is an innovative way to lift the generated multi-view images to 3D by utilizing a multi-view conditioned 3D generative model. The described technology includes learning a manifold of plausible 3D shapes conditioned on multi-view images by training expressive 3D native diffusion networks on extensive 3D data.

3D Volume Representations. As shown in FIG. 2, a textured 3D shape is represented as two discrete 3D volumes, a signed distance function (SDF) volume and a color volume. The SDF volume may measure the signed distance from the center of each grid cell to the nearest shape surface, while the color volume may capture the color of the closest surface points relative to the center of the grid cells. Additionally, the SDF volume can be transformed into a discrete occupancy volume, where each grid cell may store a binary occupancy based on whether the absolute value of its SDF is below a predefined threshold.

Two-Stage Diffusion. Capturing fine-grained details of 3D shapes may require the use of high-resolution 3D grids, which may include substantial memory and computational costs. As a result, LAS-Diffusion may be used to generate high-resolution volumes in a coarse-to-fine two-stage manner. For example, the initial stage 204 may generate a low-resolution (e.g., n=64) full 3D occupancy volume F└ [symbol] ^{n×n×n×1} to approximate the shell of the 3D shape, while the second stage 205 then may generate a high-resolution (e.g., N=128) sparse volume S∈ [symbol] ^{N×N×N×4} which predicts fine-grained SDF values and color within the occupied area.

In some embodiments, a separate diffusion network may be deployed for each stage. For the first stage, normal 3D convolution 208 may be used within the UNet to produce the full 3D occupancy volume F, while for the second stage, 3D sparse convolution 209 may be used in the UNet to yield the 3D sparse volume S. Both diffusion networks may be trained using the denoising loss:

$${ℒ}_{{x}_{0}} = {𝔼}_{ϵ ∼ 𝒩 ( 0 , I ) , t ∼ 𝒰 ( 0 , 1 )} {‖ f ( {x}_{t} , t , c ) - {x}_{0} ‖}_{2}^{2}$$

where ϵ and t are sampled noise and time step, x₀ is a data point (F or S) and xₜ is its noised version, c is the multi-view condition, and f is the UNet. N and U denote Gaussian and uniform distribution, respectively.

Multi-View Condition. Training a conventional 3D native diffusion network can be challenging to generalize due to the limited availability of 3D data. However, the use of generated multi-view images can provide a comprehensive guide, greatly simplifying the imagination difficulty of 3D generation. The multi-view images can be integrated to guide the diffusion process by initially extracting local image features and subsequently constructing a conditional 3D feature volume, denoted as C. This strategy follows the rationale that local priors facilitate easier generalization.

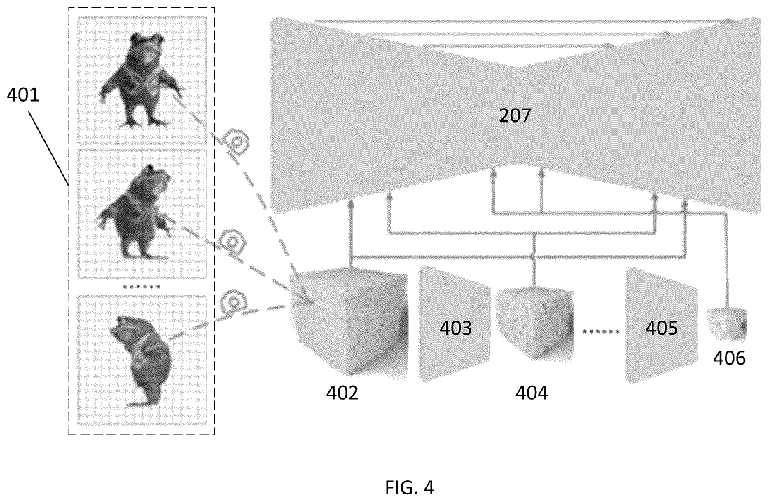

As shown in FIG. 4, given m multi-view images 401, a pretrained 2D backbone 207, e.g., DINOv2, can be employed to extract a set of local 2D patch features for each image. Then a 3D feature volume C can be built by projecting each 3D voxel within the volume onto m multi-view images using the known camera poses. For each 3D voxel, m associated 2D patch features can be aggregated through a shared-weight multi-layer perception (MLP) layer, followed by max pooling. These aggregated features can collectively form the feature volume C.

In the diffusion network, the UNet can include several levels. For example, the occupancy UNet in the initial stage may have five levels: 64³, 32³, 16³, 8^{3,} and 4^{3.} In some embodiments, a conditional feature volume C that matches the starting resolution can be constructed, as outlined earlier. A 3D convolution network can then be applied to C, producing volumes for the subsequent resolutions. For example, volume 402 can include 64³ resolution, volume 404 can include 32³ resolution, and volume 406 can include 4³ resolution. The resultant conditional volumes can then be concatenated with the volumes inside the UNet to guide the diffusion process. For the second stage, sparse conditional volumes can be constructed and 3D sparse convolution 403, 405 may be utilized. To benefit the diffusion of color volume, 2D pixel-wise projected colors can be concatenated to the final layer of the diffusion UNet. Moreover, the CLIP feature 206 of the input image can be integrated as a global condition.

Training and Inference Details. The two diffusion networks may be trained using 3D shapes from the Obajverse dataset. For each 3D shape, it may be converted to a watertight manifold before extracting its SDF volume. The multi-view renderings of the shape may be unprojected to get a 3D colored point cloud, which can be used to build the color volume. During training, the ground truth renderings can be utilized to serve as the multi-view conditions. Since two diffusion networks can be trained separately, random perturbations can be introduced to camera poses and random noises can be infused to the initial occupancy of the second stage to enhance robustness.

During inference, a 64³ grid can be first initialized with Gaussian noise to produce a dense volume 213 and then denoised by the first diffusion net. Each predicted occupied voxel can be further subdivided 212 into 8 smaller voxels, which can be used to construct a high-resolution sparse volume. The sparse volume may be initialized with Gaussian noise to produce a sparse volume 214 and then denoised with the second diffusion net, resulting in predictions for the SDF and color of each voxel. In some embodiments, the Marching Cubes algorithm 215 can be finally applied to extract a textured mesh 211.

### Texture Refinement

Given that multi-view images possess higher resolution than the 3D color volume, the texture of the generated mesh can be refined 210 through a lightweight optimization process. To achieve this, the geometry of the generated mesh can be fixed while optimizing a color field represented by a TensoRF. In each iteration, the mesh can be rendered to 2D by rasterization and querying the color network. The generated consistent multi-view images can be used to guide the texture optimization using a l2 loss. Lastly, the optimized color field can be baked or incorporated onto the mesh, with the surface normal serving as the viewing direction. A final result can include a textured 3D mesh 211 of the original input image.

### NON-LIMITING EXAMPLES

Several experiments and studies were conducted using the above methodology against several different approaches. Results are shown and described below.

### Example 1—Comparison on Image to 3D

Baselines: The described technology, dubbed One-2-3-45++, is evaluated against both optimization-based and feed-forward methods. Within the optimization-based approaches, the evaluated baselines include DreamFusion with Zero123 XL 506 (Deitke et al. “Objaverse-XL: A Universe of 10m+ 3D Objects.” arXiv preprint arXiv: 2307.05663, 2023) as its backbone, as well as SyncDreamer 508 (Liu et al. “SyncDreamer: Generating Multiview-Consistent Images from a Single-View Image.” arXiv preprint arXiv: 2309.03453, 2023.), and DreamGaussian 509 (Tang et al. “DreamGaussian: Generative Gaussian Splatting for Efficient 3D Content Creation.” arXiv preprint arXiv: 2309.16653, 2023).

For feed-forward approaches, the described technology is compared to One-2-3-45 507 and Shap-E 510 (Jun et al. “Shap-E: Generating Conditional 3D Implicit Functions.” arXiv preprint arXiv: 2305.02463, 2023). The ThreeStudio (Guo et al. ThreeStudio: A Unified Framework for 3D Content Generation.” https://github.com/threestudio-project/threestudio, 2023) implementation was used for Zero123 XL and the original official implementations for the other methods.

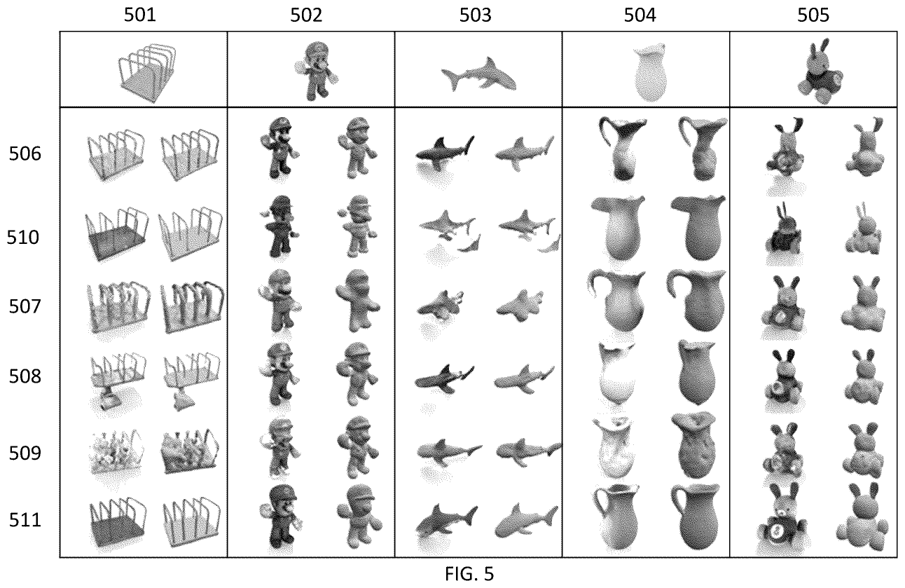

Referring to FIG. 5, the results of the six different methods are shown, in accordance with some embodiments. For each example input image, a textured mesh and normal map were generated. The first column 501 shows textured meshes and normal maps of an input image of an upright desk file organizer. The second column 502 shows textured meshes and normal maps of an input image of Mario, the video game and cartoon character. The third column 503 shows textured meshes and normal maps of an input image of a shark. The fourth column 504 shows textured meshes and normal maps of an input image of a tall pitcher. The fifth column 505 shows textured meshes and normal maps of an input image of a rabbit with wheels as legs plush toy.

Dataset and Metrics: The performance of the methods was assessed using the entire set of 1,030 shapes from the GSO dataset (Downs et al. “Google Scanned Objects: A High-Quality Dataset of 3D Scanned Household Items.” In 2022 International Conference on Robotics and Automation (ICRA), pages 2553-2560. IEEE, 2022), which were not exposed to any of the methods during training. For each shape, a frontal view image was generated to serve as the input. In line with One-2-3-45, the F-Score and CLIP similarity were deployed as the evaluation metrics. The F-Score evaluates the geometric similarity between the predicted mesh and the ground truth mesh. For the CLIP similarity metric, 24 different views for each predicted and ground truth mesh were rendered, the CLIP similarity for each corresponding pair of images were computed, and then these values were averaged across all views. Prior to metric computation, the predicted mesh with the ground truth mesh were aligned using a combination of linear search and the ICP algorithm.

TABLE 1

| | | | User-Pref. | | |
|---|---|---|---|---|---|
| Method | F-Sco. (%)↑ | CLIP-Sim↑ | (%)↑ | Time↓ | |
| Zero123 XL 506 | 91.6 | 73.1 | 58.6 | 30 | min |
| One-2-3-43 507 | 90.4 | 70.8 | 52.7 | 45 | s |
| SyncDreamer 508 | 84.8 | 68.9 | 28.4 | 6 | min |
| DreamGaussian 509 | 81.0 | 68.4 | 31.5 | 2 | min |
| Shap-E 510 | 91.8 | 73.1 | 40.8 | 27 | s |
| One-2-3-45++ 511 | 93.6 | 81.0 | 87.6 | 60 | s |

User Study: A user study was also carried out. For each participant, 45 shapes were randomly selected from the entire GSO dataset, and two methods were randomly sampled for each shape. Participants were asked to choose the result from each pair of comparative outcomes that exhibits superior quality and better aligns with the input image. The preference rate for all methods was then tallied based on these selections. In total, 2,385 evaluated pairs were collected from 53 participants.

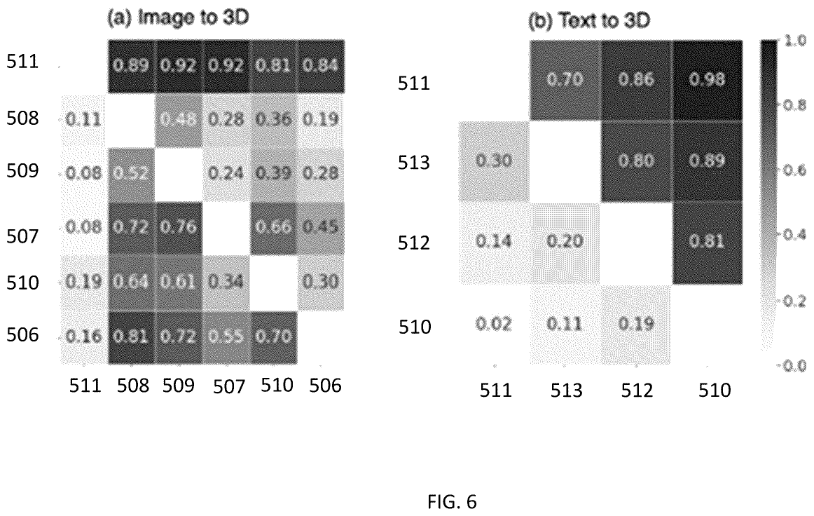

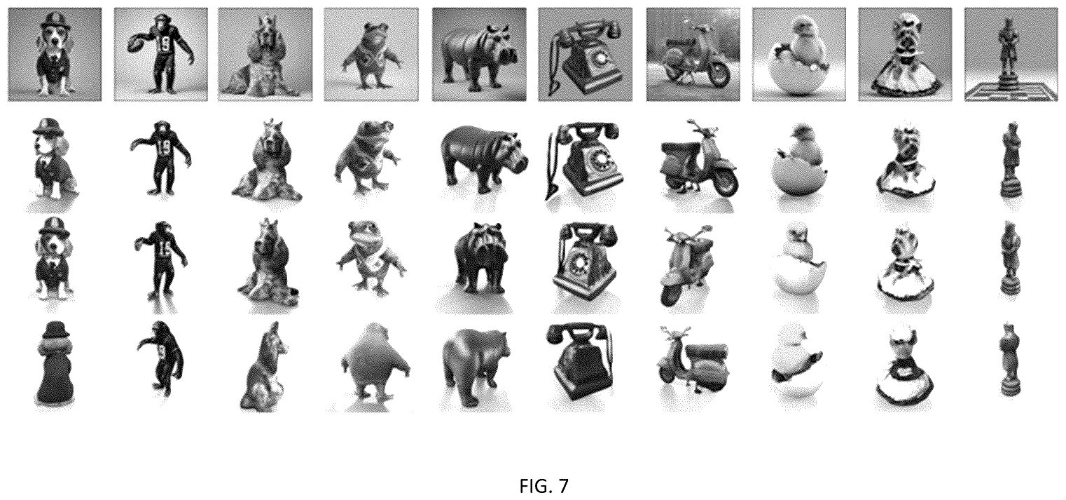

Results: As presented in Table 1, One-2-3-45++ surpasses all baseline methods regarding F-Score and CLIP similarity. The user preference scores further highlight a significant performance disparity, with the One-2-3-45++ method outperforming competing approaches by a substantial margin. Refer to FIG. 6 for an in-depth confusion matrix, in accordance with some embodiments. In the matrix, each cell displays the probability or preference rate at which one method (row) outperforms another (column). The matrix illustrates that One-2-3-45++ outperformed One-2-3-45 92% of the time for this test. Moreover, when compared to optimization-based methods, the described approach demonstrates notable runtime advantages. FIGS. 5 and 7 show qualitative results.

### Example 2—Comparison on Text to 3D

Baselines: We compared One-2-3-45++ with optimization-based methods, specifically ProlificDreamer 512 (Wang et al. “ProlificDreamer: High-Fidelity and Diverse Text-to-3D Generation with Variational Score Distillation.” arXiv preprint arXiv: 2305.16213, 2023) and MV-Dream 513 (Shi et al. “MVDream: Multi-view Diffusion for 3D Generation.” arXiv preprint arXiv: 2308.16512, 2023), as well as a feed-forward approach, Shap-E 510. For ProlificDreamer, the ThreeStudio implementation was utilized (Guo et al. “threestudio: A Unified Framework for 3D Content Generation.” https://github.com/threestudio-project/threestudio, 2023), while for the remaining methods, their respective official implementations were used.

Dataset and Metrics: Given that many baseline approaches necessitate hours to produce a single 3D shape, the evaluation was conducted on 50 text prompts, sampled from DreamFusion. CLIP similarity was used which was calculated by comparing 24 rendered views of the predicted mesh against the input text prompt and then averaging the similarity scores across all views.

User Study: The user study, akin to the image-to-3D evaluation, involved 30 pairs of outcomes randomly selected for each participant. In total, 1,590 evaluation pairs were collected from 53 participants.

TABLE 2

| Method | CLIP-Sim↑ | User-Pref.↑ | Runtime↓ | |
|---|---|---|---|---|
| ProlificDreamer 512 | 25.7 | 39.5 | 10 | h+ |
| MVDream 513 | 24.8 | 66.2 | 2 | h |
| Shap-E 510 | 22.3 | 11.1 | 27 | s |
| One-2-3-45++ 511 | 26.8 | 84.1 | 60 | s |

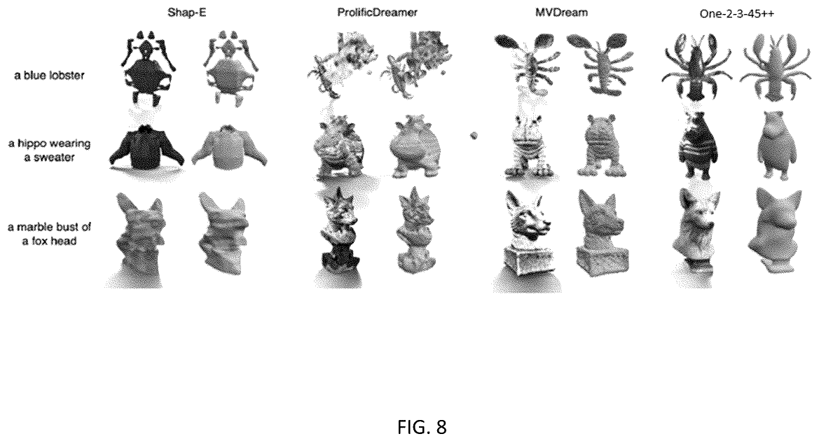

Results: As illustrated in Table 2, One-2-3-45++ outperforms all baseline methods in terms of CLIP similarity. This is further corroborated by user preference scores, with the disclosed method significantly outshining rival techniques. See FIG. 6 for an in-depth analysis. When directly comparing One-2-3-45++ with the second-best method, MVDream, the disclosed approach commands a 70% user preference rate. Moreover, while the disclosed method delivers prompt results, MVDream requires about 2 hours to generate a single shape. FIG. 8 shows qualitative results.

### Analysis

Ablation Studies of Overall Pipeline. One-2-3-45++ may include three or modules: consistent multi-view generation, multi-view conditioned 3D diffusion, and texture refinement, but embodiments are not limited thereto. Ablation studies were conducted on these modules using the complete GSO dataset, with results detailed in Table 3 below.

TABLE 3

| MultiView | Reconstruction | Texture | F-Sc.↑ | CLIP-Sim↑ | Time↓ |
|---|---|---|---|---|---|
| Zero123 XL | Ours | w/o | 92.9 | 71.9 | 14 s |
| Ours | SparseNeuS | w/o | 81.2 | 67.2 | 15 s |
| Ours | Ours | w/o | 93.6 | 73.4 | 20 s |
| Ours | Ours | w/ | 93.6 | 81.0 | 60 s |

Replacing the disclosed consistent multi-view generation module with Zero123XL led to a noticeable performance decline. Furthermore, substituting the disclosed 3D diffusion module with the generalizable NeRF used in One-2-3-45 resulted in an even more significant performance drop. However, the inclusion of the disclosed texture refinement module markedly improved texture quality, yielding higher CLIP similarity scores.

Table 4 presents the results of an ablation study of the 3D diffusion module. The study highlights the importance of multi-view images for the module's efficacy. When the module operates without multi-view conditions, relying solely on the global CLIP feature from a single input view (rows a and f), there is a significant decline in performance. Conversely, the One-2-3-45++ approach may leverage multi-view local features by constructing a 3D feature volume with known projection matrices. A mere concatenation of global CLIP features from multiple views also impairs performance (rows b and f), underlining the value of multi-view local conditions. Global CLIP features of the input view, however, may provide global shape semantics; their removal results in decreased performance (rows c and e). Although One-2-3-45++ uses predicted multi-view images for 3D reconstruction, incorporating these predicted images during training of the 3D diffusion module can lead to a performance downturn (rows d and e) due to the potential mismatch between the predicted multi-view images and actual 3D ground truth meshes. To train the module effectively, ground truth renderings were used. Recognizing that predicted multi-view images may be flawed, random perturbations are introduced to projection matrices during training to enhance robustness when processing predicted multi-view images (rows e and f).

TABLE 4

| | multi-view | | | proj. | |
|---|---|---|---|---|---|
| id | cond. | global cond. | image source | perturb. | 3D IoU ↑ |
| a | w/o | w/ | rendering | N/A | 18.3 |
| b | global | w/ | rendering | N/A | 24.4 |
| c | local | w/o | rendering | w/o | 41.4 |
| d | local | w/ | prediction | w/o | 41.3 |
| e | local | w/ | rendering | w/o | 44.1 |
| f | local | w/ | rendering | w/ | 45.1 |

Comparison on Multi-View Generation The consistent multi-view generation module was evaluated against existing approaches, namely Zero123 and its scaled variant, alongside two concurrent works: SyncDreamer and Wonder3D (Long et al. “Wonder3D: Single image to 3D using cross-domain diffusion.” arXiv: 2310.15008, 2023). This comparison utilizes the GSO dataset, where for each object, a single input image is rendered, and the methods were tasked with producing multi-view images. For Zero123 and Zero123 XL, the same target poses were used as the disclosed technology. However, for Wonder3D and SyncDreamer, the target poses were employed that were preset by these methods, as they do not support altering camera positions during inference. As presented in Table 5, the disclosed technology surpasses current methodologies in peak signal-to-noise ratio (PSNR), learned perceptual image patch similarity (LPIPS), and foreground mask intersection over union (IoU). Notably, Wonder3D employs orthographic projection in its training phase, which compromises its robustness when dealing with perspective images during inference. SyncDreamer only generates views at an elevation of 30°, a simpler setting than One-2-3-45++.

TABLE 5

| | Target Elevations | PSNR ↑ | LPIPS ↓ | Mask IoU ↑ |
|---|---|---|---|---|
| Zero123 | 30° and −20° | 20.32 | 0.110 | 0.856 |
| Zero123 XL | | 20.11 | 0.113 | 0.869 |
| Ours | | 22.12 | 0.110 | 0.878 |
| SyncDreamer | 30° | 21.67 | 0.095 | 0.894 |
| Wonder3D | 0° | 18.67 | 0.130 | 0.635 |

### Robot Training and Manipulation Based on Generated 3D Meshes

In certain embodiments, the system and method described herein may be advantageously employed to train robotic systems in simulation environments before deployment in physical settings, thereby reducing development time, cost, and potential safety hazards associated with real-world robot training. The generated textured 3D meshes provide high-fidelity virtual representations of real-world objects that can be integrated into physics-based simulation environments, enabling robots to learn interaction patterns with these objects without the need for extensive physical prototyping or data collection.

The use of these generated 3D models offers significant advantages over conventional methods of robot training. Traditional approaches often rely on manually created 3D models, which are time-consuming to produce and may lack the detailed textural and geometric fidelity necessary for effective transfer learning. In contrast, the disclosed technology allows for rapid generation of photorealistic 3D models from single 2D images, enabling the creation of large and diverse training datasets with minimal human intervention. This capability is particularly valuable in scenarios where collecting real-world interaction data would be prohibitively expensive, dangerous, or physically impossible.

The simulation environment incorporating these generated 3D meshes may include physics engines that accurately model the dynamic properties of the objects, including mass distribution, friction coefficients, and collision responses. These properties may be inferred from the geometry of the generated 3D meshes or assigned based on predefined material properties associated with the object classification. By simulating physical interactions between the robot and the generated 3D objects, the system can create a realistic training ground for developing and refining robotic control algorithms, perception systems, and manipulation strategies.

Furthermore, the simulation environment may be configured to introduce controlled variability in lighting conditions, object positions, orientations, and other environmental factors to enhance the robustness of the trained robot models. This variability helps prevent overfitting to specific scenarios and promotes the development of generalized skills that can transfer effectively to real-world settings. The high visual fidelity of the generated textured 3D meshes is particularly important in this context, as it helps bridge the “reality gap” that often hampers the transfer of policies learned in simulation to physical robot systems.

In some embodiments, the system may generate a diverse array of 3D meshes representing various objects from a database of 2D images, creating a comprehensive virtual training environment for robotic systems. This approach enables the creation of complex, multi-object scenes that simulate realistic workspaces such as warehouses, domestic environments, manufacturing facilities, or outdoor settings. By populating the virtual environment with multiple generated 3D objects, the system can provide a richer context for robot learning that more closely approximates the complexity of real-world operational scenarios.

The virtual training environment may be structured to present progressively challenging tasks to the robot, beginning with basic object recognition and simple manipulation activities before advancing to more complex multi-step procedures involving multiple objects. For example, a robot might first learn to identify and grasp individual objects before progressing to tasks such as sorting objects by category, assembling components, navigating cluttered environments, or collaborating with other robotic or simulated human agents. This curriculum-based approach to training facilitates efficient skill acquisition and helps identify potential failure modes in a safe, controlled setting before deployment in physical environments.

The system may employ various machine learning paradigms within this virtual environment, including but not limited to reinforcement learning, imitation learning, or hybrid approaches. In reinforcement learning scenarios, the robot receives reward signals based on successful completion of tasks involving the generated 3D objects, optimizing its policy over many iterations of interaction. In imitation learning approaches, the system may generate demonstration trajectories showing optimal interaction with the 3D objects, which the robot then learns to emulate. These learning approaches benefit significantly from the visual and geometric fidelity of the generated 3D meshes, as they provide realistic perceptual inputs for the robot's vision systems and accurate collision models for interaction.

Moreover, the system may implement domain randomization techniques, wherein properties of the generated 3D meshes, such as colors, textures, sizes, masses, or friction coefficients, are systematically varied within reasonable bounds to enhance the robustness of the trained policies. This technique can help to ensure that the robot does not overfit to specific visual or physical properties of the training objects and can generalize effectively to new instances encountered in the real world. The ability to rapidly generate multiple variations of 3D objects from single images can facilitate this approach by providing diverse training examples without requiring extensive manual modeling or real-world data collection.

In some embodiments, the method incorporates physics-based simulation capabilities that model realistic interactions between robotic systems and the generated 3D objects. These physics simulations account for gravitational forces, contact dynamics, friction, material deformation properties, and other physical phenomena that influence object behavior during manipulation. By accurately modeling these physics-based interactions, the system can enable robots to learn manipulation strategies that respect the physical constraints of the real world, resulting in more effective transfer of learned skills to physical robot platforms.

The simulation environment may collect comprehensive data during robot-object interactions, recording variables such as applied forces, torques, contact points, object trajectories, and task success metrics. This high-dimensional interaction data can serve as training input for machine learning models that predict optimal strategies for object manipulation. The collected data may be used to train neural networks that map from perceptual inputs (e.g., camera images or depth maps of the generated 3D objects) to manipulation parameters such as grasp points, approach vectors, applied forces, or multi-step action sequences. The richness of the interaction data facilitated by the high-fidelity 3D meshes allows these models to capture subtle aspects of effective manipulation that might be missed in simplified simulation environments.

The trained machine learning models may incorporate various architectural innovations suited to robotic control tasks, such as convolutional neural networks for visual processing, recurrent networks for temporal reasoning, attention mechanisms for focusing on relevant object features, or graph neural networks for modeling relational properties between multiple objects. These models may be trained using supervised learning when demonstration data is available, or through reinforcement learning when reward signals can be defined based on task completion or other success criteria. The system may also employ transfer learning techniques, leveraging pre-trained visual feature extractors that have been fine-tuned on the generated 3D meshes to accelerate learning in new task domains.

After training in simulation, the resulting models may be deployed on physical robot systems with appropriate calibration to account for differences between simulated and real-world conditions. This deployment process may include a domain adaptation phase where the robot interacts with a limited set of physical objects corresponding to the simulated 3D models, allowing for fine-tuning of the learned policies to accommodate real-world sensor noise, actuator limitations, or other factors not perfectly captured in simulation. The high visual and geometric fidelity of the generated 3D meshes can help minimize the necessary adaptation by reducing the reality gap between simulation and physical deployment environments.

In some embodiments, the system can generate controlled variations of the 3D meshes to enhance the robustness and generalization capabilities of trained robotic systems. These variations may include systematic alterations to the mesh geometry (scaling, stretching, or slight deformations), texture properties (color shifts, pattern variations, or material changes), or pose configurations (rotations, translations, or articulations of parts). By training with these varied representations, robots develop manipulation policies that are invariant to non-essential object features while remaining sensitive to task-relevant properties, leading to more reliable performance when encountering previously unseen object instances in the real world.

The system may employ generative models to create these variations, using techniques such as interpolation in the latent space of the 3D diffusion model, application of style transfer algorithms to texture maps, or procedural generation of geometric modifications that preserve functional object properties while altering non-functional aspects. These generative approaches allow for the creation of virtually unlimited training examples from a limited set of initial 3D meshes, providing the volume and diversity of data necessary for effective deep learning without requiring extensive manual modeling or data collection efforts. The variations may be constrained to maintain physical plausibility and to respect the semantic identity of the original objects, ensuring that the robot learns meaningful and transferable interaction strategies.

Environmental factors within the simulation may also be systematically varied to promote policy robustness. These factors include lighting conditions (intensity, direction, color temperature, shadows), background elements (supporting surfaces, nearby objects, occlusions), camera properties (position, orientation, focal length, noise characteristics), and environmental dynamics (vibrations, air currents, moving parts). By training under diverse environmental conditions, the robot can develop perceptual systems that can reliably identify and localize objects across varying contexts, which is essential for successful deployment in uncontrolled real-world settings. The high-fidelity textured meshes generated by the disclosed technology can provide rich visual details that enable this form of robust perceptual learning.

The system may also implement active learning strategies, wherein the robot or learning algorithm itself selects which object variations or environmental conditions to train on next, based on measures of uncertainty, expected information gain, or estimated improvement potential. This approach can focus computational resources on the most informative training examples, accelerating learning and improving final performance. The ability to rapidly generate custom variations of 3D meshes based on specific learning needs provides the flexibility required for effective active learning implementations. As the robot's capabilities improve, the system may automatically increase the subtlety and complexity of the generated variations, maintaining an optimal challenge level throughout the training process.

Herein is disclosed systems, methods, and articles of manufacture for “One-2-3-45++”, which is an innovative approach for transforming a single image of any object into a 3D textured mesh. This method stands out by offering more precise control compared to existing text-to-3D models, and it is capable of delivering high-quality meshes swiftly, typically in under 60 seconds. Additionally, the generated meshes exhibit a high fidelity to the original input image. The generated 3D meshes can be used to train robots as discussed above.

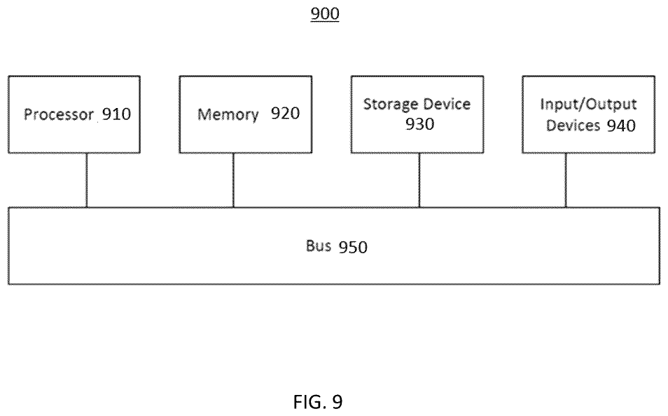

In some implementations, the current subject matter (e.g., generating 3D meshes based on 2D images and generating simulation environments for training robots) may be configured to be implemented in a system 900, as shown in FIG. 9. For example, aspects disclosed herein may be at least in part physically comprised on system 900. To illustrate further system 900 may further include an operating system, a hypervisor, and/or other resources, to provide the noted machine learning models. The system 900 may include a processor 910, a memory 920, a storage device 930, and an input/output device 940. Each of the components (e.g., 910, 920, 930 and 940) may be interconnected using a system bus 950. The processor 910 may be configured to process instructions for execution within the system 900. In some implementations, the processor 910 may be a single-threaded processor. In alternate implementations, the processor 910 may be a multi-threaded processor. In some embodiments, the processor 910 may include multiple processors and/or graphics processing units (GPUs) that can be used for training and/or inference.

The processor 910 may be further configured to process instructions stored in the memory 920 or on the storage device 930, including receiving or sending information through the input/output device 940. The memory 920 may store information within the system 900. In some implementations, the memory 920 may be a computer-readable medium. In alternate implementations, the memory 920 may be a volatile memory unit. In yet some implementations, the memory 920 may be a non-volatile memory unit. The storage device 930 may be capable of providing mass storage for the system 900. In some implementations, the storage device 930 may be a computer-readable medium. In alternate implementations, the storage device 930 may be a floppy disk device, a hard disk device, an optical disk device, a tape device, non-volatile solid state memory, or any other type of storage device. The input/output device 940 may be configured to provide input/output operations for the system 900. In some implementations, the input/output device 940 may include a keyboard and/or pointing device. In alternate implementations, the input/output device 940 may include a display unit for displaying graphical user interfaces.

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed:

1. A method for generating a three-dimensional (3D) model from a single two-dimensional (2D) image, the method comprising:
receiving a single 2D input image of an object;
generating a set of consistent multi-view images based on the single 2D input image using a fine-tuned 2D diffusion model that processes multiple views together in a tiled configuration;
constructing a 3D feature volume by projecting 2D patch features from the generated multi-view images using corresponding camera pose information;
generating a 3D mesh using a pair of 3D diffusion networks conditioned on the multi-view images, wherein the pair of 3D diffusion networks comprises a first network for generating a coarse occupancy volume and a second network for generating a high-resolution sparse volume; and
refining a texture of the generated 3D mesh to produce a textured 3D mesh.

2. The method of claim 1, wherein generating the set of consistent multi-view images comprises:
tiling six views into a single image with a 3×2 layout;
defining camera poses for the multi-view images using fixed absolute elevation angles alternating between about 30° and about −20°, coupled with azimuths commencing at about 30° and incrementing by about 60° for each subsequent pose; and
generating the tiled image using the fine-tuned 2D diffusion model conditioned on the single 2D input image.

3. The method of claim 1, wherein the fine-tuned 2D diffusion model incorporates:
local conditioning through reference attention that appends self-attention key and value matrices from the 2D input image to corresponding attention layers for the multi-view image;
global conditioning using contrastive language-image pre-training image embedding as a global semantic understanding of the object; and
a linear noise scheme for the diffusion process.

4. The method of claim 1, wherein generating the 3D mesh comprises:
initializing a low-resolution 3D grid with Gaussian noise;
denoising the grid using the first diffusion network to produce a coarse occupancy volume;
subdividing each predicted occupied voxel into smaller voxels to construct a high-resolution sparse volume;
initializing the sparse volume with Gaussian noise;
denoising the sparse volume using the second diffusion network to predict signed distance function (SDF) values and color for each voxel; and
applying a Marching Cubes algorithm to extract a textured mesh from the denoised volume.

5. The method of claim 1, wherein refining the texture of the generated 3D mesh comprises:
rendering the 3D mesh from multiple views that match the camera poses of the generated multi-view images;
comparing the rendered views with the generated multi-view images;
optimizing a color field to minimize differences between the rendered views and the generated multi-view images using a l2 loss function; and
transferring the optimized color field to the surface of the textured 3D mesh surface.

6. The method of claim 1, further comprising:
processing the generated textured 3D mesh to create simplified collision models for physical simulation;
analyzing one or more geometric properties of the 3D mesh to identify potential grasping points and manipulation affordances; and
using the identified affordances to guide robot interaction planning when working with objects resembling the generated 3D model.

7. The method of claim 1, further comprising training a robot to interact with physical objects by using the generated textured 3D mesh in a simulation environment that simulates physical interactions between the robot and virtual representations of the physical objects.

8. The method of claim 7, further comprising:
generating multiple different 3D meshes of various objects from corresponding 2D input images;
populating a virtual training environment with the generated 3D meshes; and
training the robot in the virtual training environment to perform grasping, manipulation, and navigation tasks with respect to objects represented by the 3D meshes.

9. The method of claim 8, wherein training the robot in the virtual environment further comprises:
generating variations of the 3D meshes with different textures, sizes, and orientations to enhance the robustness of the robot's learned policies;
simulating different lighting conditions and environmental factors to improve generalization capability of the robot; and
gradually increasing the complexity of manipulation tasks to enable progressive learning.

10. The method of claim 7, wherein training the robot in the simulation environment comprises:
simulating physics-based interactions between the robot and the generated 3D objects;
collecting training data from the simulated interactions;
using the collected data to train machine learning models that predict optimal grasping points, manipulation strategies, and object recognition capabilities; and
deploying the trained models on physical robots to enable effective interaction with real-world counterparts of the simulated objects.

11. A system for generating a three-dimensional (3D) model from a single two-dimensional (2D) image, the system comprising:
one or more processors; and
at least one memory storing instructions that, when executed by the one or more processors, cause the system to:
receive a single 2D input image of an object;
generate a set of consistent multi-view images based on the single 2D input image using a fine-tuned 2D diffusion model that processes multiple views together in a tiled configuration;
construct a 3D feature volume by projecting 2D patch features from the generated multi-view images using corresponding camera pose information;
generate a 3D mesh using a pair of 3D diffusion networks conditioned on the multi-view images, wherein the pair of 3D diffusion networks comprises a first network for generating a coarse occupancy volume and a second network for generating a high-resolution sparse volume; and
refine a texture of the generated 3D mesh to produce a textured 3D mesh.

12. The system of claim 11, wherein generating the set of consistent multi-view images comprises:
tiling multiple views of the object into a single composite image arranged in a grid layout; and
generating the composite image using the fine-tuned 2D diffusion model conditioned on the single 2D input image, enabling cross-view attention during the diffusion process.

13. The system of claim 11, wherein the fine-tuned 2D diffusion model is configured to generate the multi-view images with predetermined camera poses comprising:
fixed absolute elevation angles; and
relative azimuth angles with respect to the input image view.

14. The system of claim 11, wherein the first network of the pair of 3D diffusion networks generates a low-resolution occupancy volume using 3D convolution, and the second network generates a high-resolution sparse volume using 3D sparse convolution.

15. The system of claim 11, wherein the instructions further cause the system to refine the texture of the generated 3D mesh by:
optimizing a color field represented by a tensor radiance field (TensoRF) while maintaining a geometry of the generated 3D mesh; and
baking the optimized color field onto the mesh.

16. The system of claim 11, wherein constructing the 3D feature volume comprises:
extracting 2D patch features from each of the multi-view images using a pre-trained vision model;
projecting each 3D voxel within the 3D feature volume onto the multi-view images using known camera poses; and
aggregating corresponding 2D patch features through a shared-weight multilayer perceptron followed by max pooling.

17. The system of claim 11, wherein the instructions further cause the system to perform text-to-3D generation by:
receiving a text prompt describing an object;
synthesizing a reference image based on the text prompt using a text-to-image model; and
processing the synthesized reference image through the consistent multi-view generation and 3D diffusion pipeline to produce a textured 3D mesh corresponding to the text prompt.

18. The system of claim 11, wherein the instructions further cause the system to train a robot to interact with physical objects by using the generated textured 3D mesh in a simulation environment that simulates physical interactions between the robot and virtual representations of the physical objects.

19. The system of claim 18, wherein the instructions further cause the system to:
generate multiple different 3D meshes of various objects from corresponding 2D input images;
populate a virtual training environment with the generated 3D meshes; and
train the robot in the virtual training environment to perform object manipulation tasks before deployment in a physical environment.

20. The system of claim 18, wherein training the robot using the simulation environment comprises:
using reinforcement learning to train robot control policies based on interactions with the generated 3D meshes; and
transferring the learned policies to a physical robot for real-world object manipulation.
